(19) United States
(12) Patent Application Publication
(10) Pub. No.: US 2018/0364412 A1
(43) Pub. Date: Dec. 20, 2018

(54) BACKLIGHT MODULE AND DISPLAY DEVICE

(71) Applicant: SHANGHAI TIANMA MICRO-ELECTRONICS CO., LTD., Shanghai (CN)

(72) Inventor: Yongli YAO, Shanghai (CN)

(21) Appl. No.: 15/785,292

(22) Filed: Oct. 16, 2017

(30) Foreign Application Priority Data
Jun. 14, 2017 (CN) 201710445820.5

(51) Int. Cl. F21V 8/00

(52) U.S. Cl. CPC G02B 6/0053; G02B 6/0055; G02B 6/0051; G02B 6/005

(57) ABSTRACT

The application discloses a backlight module and a display device, and the backlight module includes a light guiding plate, and a light deflector arranged on the side of a light exit face of the light guiding plate, where the light deflector includes a prism module; and the light deflector includes a plurality of light deflecting elements having a same structure, where the respective light deflecting elements are asymmetrically structured inclined from the normal perpendicular to the light exit face of the light guiding plate so that an angle of view of light exiting from the backlight module is deflected from the normal. The prism module includes at least one layer of prism sheet, and there are a plurality of strip-shaped convex prisms arranged in parallel on the surface of the prism sheet away from the light guiding plate.

### CROSS-REFERENCE TO RELATED APPLICATIONS

This application claims the priority to Chinese Patent Application No. 201710445820.5, filed on Jun. 14, 2017, the content of which is hereby incorporated by reference in its entirety.

### FIELD OF INVENTION

The present disclosure relates to the field of display technologies, and particularly to a backlight module and a display device.

### BACKGROUND OF INVENTION

A Thin Film Transistor Liquid Crystal Display (TFT-LCD) in an existing display devices has been predominant in the current market of flat panel displays due to its small volume, low power consumption, low production cost, no radiation, and other characteristics.

A liquid crystal display device generally includes a backlight module and a display panel, where the display panel itself does not emit any light, and the backlight module provides the display panel with a light source. Brightness, uniformity of emergent light, an angle of view, and other important parameters of a liquid crystal display screen are determined by the quality of light production from the backlight module which is an important component in the liquid crystal display device, so an effect of light emission from the liquid crystal display screen is significantly affected by the quality of light production from the backlight module.

The angle of view of the existing liquid crystal display screen is symmetric, so an angle of view which can be created by light rays exiting from the backlight module is also symmetric. In a real application, the angle of view of the liquid crystal display screen frequently needs to be twisted. For example, there is a driver watching an on-vehicle liquid crystal display screen with a symmetric angle of view, where there is higher brightness or another better display effect at an angle of view around the middle of the liquid crystal display screen. However, the driver typically looks down at the liquid crystal display screen instead of watching it at the optimum angle of view thereof, that is, he or she watches the liquid crystal display screen at a large angle of view, so it is difficult for the existing display screen to accommodate the special angle of view, which is not symmetric, as required above.

### SUMMARY OF INVENTION

Embodiments of the disclosure provide a backlight module and a display device so as to accommodate a special asymmetric angle of view as required for the backlight module and the display device.

In a first aspect, an embodiment of the disclosure provides a backlight module including: a light guiding plate, and a light deflector arranged on the side of a light exit face of the light guiding plate, wherein the light deflector includes a prism module; and the light deflector includes a plurality of light deflecting elements having a same structure, wherein respective light deflecting elements are asymmetrically structured to be inclined from a normal, wherein the normal is perpendicular to the light exit face of the light guiding plate so that an angle of view of light exiting from the backlight module is deflected from the normal; and the prism module further includes at least one layer of prism sheet comprising of a plurality of strip-shaped convex prisms arranged in parallel on the surface of the prism sheet away from the light guiding plate.

In a second aspect, an embodiment of the disclosure provides a display device including a backlight module, and a display panel located on the light exit side of the backlight module, wherein the backlight module includes: a light guiding plate, and a light deflector arranged on the side of a light exit face of the light guiding plate, wherein the light deflector includes a prism module; and the light deflector includes a plurality of light deflecting elements having a same structure, wherein respective light deflecting elements are asymmetrically structured to be inclined from a normal, wherein the normal is perpendicular to the light exit face of the light guiding plate so that an angle of view of light exiting from the backlight module is deflected from the normal; and the prism module further includes at least one layer of prism sheet comprising of a plurality of strip-shaped convex prisms arranged in parallel on the surface of the prism sheet away from the light guiding plate.

Advantageous effects of the disclosure are as follows.

In the backlight module and the display device according to the embodiments of the disclosure, the backlight module includes the light guiding plate, and the light deflector arranged on the side of the light exit face of the light guiding plate, where the light deflector includes the prism module; and the light deflector includes a plurality of light deflecting elements having a same structure, where the respective light deflecting elements are asymmetrically structured inclined from the normal perpendicular to the light exit face of the light guiding plate so that an angle of view of light exiting from the backlight module is deflected from the normal. The prism module includes at least one layer of prism sheet, and there are a plurality of strip-shaped convex prisms arranged in parallel on the surface of the prism sheet away from the light guiding plate. The light deflecting elements in the asymmetrical structure are arranged so that the light exiting from the backlight module is deflected from the original direction to the normal to thereby make the exiting light also deflected, thus creating the special asymmetrical angle of view as required on a display screen.

### BRIEF DESCRIPTION OF THE DRAWINGS

FIG. 1 is a first schematic structural diagram of a backlight module according to an embodiment of the disclosure;

FIG. 2 is a schematic structural diagram of a light control film according to an embodiment of the disclosure;

FIG. 3A is a second schematic structural diagram of a backlight module according to an embodiment of the disclosure;

FIG. 3B is a schematic structural diagram of a light deflecting element according to an embodiment of the disclosure;

FIG. 3C is a light path comparison diagram on a strip-shaped convex prism according to an embodiment of the disclosure;

FIG. 3D is an angle of view comparison diagram of a light control film according to an embodiment of the disclosure;

FIG. 4 is a distribution diagram of brightness according to an embodiment of the disclosure;

FIG. 5 is a first angle of view and detection area correspondence diagram according to an embodiment of the disclosure;

FIG. 6 is a second angle of view and detection area correspondence diagram according to an embodiment of the disclosure;

FIG. 7 is a third schematic structural diagram of a backlight module according to an embodiment of the disclosure;

FIG. 8 is a fourth schematic structural diagram of a backlight module according to an embodiment of the disclosure;

FIG. 9 is a fifth schematic structural diagram of a backlight module according to an embodiment of the disclosure;

FIG. 10 is a schematic structural diagram of a prism module according to an embodiment of the disclosure;

FIG. 11A is a first schematic sectional view of a strip-shaped convex prism according to an embodiment of the disclosure;

FIG. 11B is a light path comparison diagram at the top corner of the strip-shaped convex prism according to an embodiment of the disclosure;

FIG. 11C is a schematic diagram of an arc at the top corner of the strip-shaped convex prism according to an embodiment of the disclosure;

FIG. 12 is a second schematic sectional view of a strip-shaped convex prism according to an embodiment of the disclosure;

FIG. 13 is a sixth schematic structural diagram of a backlight module according to an embodiment of the disclosure;

FIG. 14A is a schematic plan view of an on-vehicle display according to an embodiment of the disclosure; and

FIG. 14B is a schematic sectional view of an on-vehicle display according to an embodiment of the disclosure.

### DETAILED DESCRIPTION OF THE EMBODIMENTS

Embodiments of the disclosure provide a backlight module and a display device so as to accommodate a special asymmetric angle of view as required for the backlight module and the display device.

In order to make the objectives, features, and advantages above of the disclosure more apparent, the disclosure will be described below in further details with reference to the drawings and the embodiments thereof. However the exemplary embodiments can be put into practice in a number of forms, and shall not be construed to be limited to the embodiments described here; and on the contrary, these embodiments are provided to make the disclosure of the disclosure more complete, and to convey the idea of the exemplary embodiments fully to those skilled in the art. Like reference numerals in the drawings represent identical or like components, so a repeated description thereof will be omitted. The terms to be described in the disclosure to represent a position and a direction will be described with reference to the drawings by way of an example, but may be modified as needed, and all the modifications thereto shall fall into the scope of the disclosure as claimed. The drawings in the disclosure are merely intended to illustrate a relative positional relationship, and the thicknesses of some parts are illustratively exaggerated for the sake of convenient understanding, but the thicknesses thereof as illustrated shall not suggest any proportional relationship between the real thicknesses.

It shall be noted that particular details will be described below to facilitate full understanding of the disclosure. However the disclosure can be embodied in a plurality of other implementations than those described herein and alike those skilled in the art can generalize them without departing from the spirit of the disclosure. Accordingly the disclosure will not be limited to the particular embodiments disclosed below. For example, if one component is located on “the side facing” of another component as referred to throughout the description and the claims, then the component may or may not be adjacent to the other component. For example, if one component is located on “the side away from” another component as referred to throughout the description and the claims, then the component may or may not be adjacent to the other component. Preferred embodiments of the disclosure will be described below in the specification, but they will be described for the purpose of illustrating a general principle of the disclosure, but not intended to limit the scope of the disclosure thereto. The scope of the disclosure as claimed shall be as defined in the appended claims.

A backlight module and a display device according to embodiments of the disclosure will be described below in detail with reference to the drawings in which the thicknesses and shapes of respective components are not intended to reflect any real proportion of the backlight module and the display device, but only intended to illustrate the discourse of the disclosure.

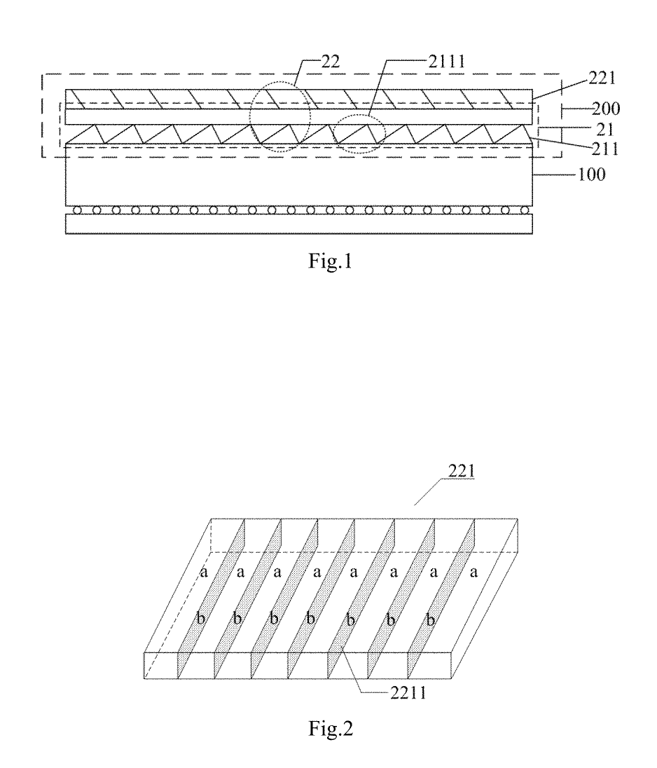

With reference to FIG. 1 which is a first schematic structural diagram of a backlight module according to an embodiment of the disclosure, the backlight module according to the embodiment of the disclosure as illustrated in FIG. 1 includes: a light guiding plate 100, and a light deflector 200 arranged on the side of a light exit face of the light guiding plate 100, where the light deflector 200 includes a prism module 21, and the light deflector 200 includes a plurality of light deflecting elements 22 having a same structure, where the respective light deflecting elements 22 are asymmetrically structured to be inclined from the normal, and the normal is perpendicular to the light exit face of the light guiding plate, so that an angle of view of light exiting from the backlight module is deflected from the normal.

In a particular application, the light deflector 200 can be regarded as an optical system located at the light exit face of the light guiding plate 100, and light exiting from the light guiding plate 100, which would otherwise be transmitted in respective directions, passes the symmetrically structured optical system so that there is also a symmetric angle of view covered by the resulting exiting light. In the embodiment of the disclosure, the light deflecting elements 22 in the light deflector 200 are asymmetrically structured so that the exiting light, which would otherwise be transmitted in the respective directions, passes through the asymmetrical light deflecting elements 22 so that the overall light path thereof is deflected in a preset direction, and thus there is an asymmetric angle of view covered by the resulting exiting light rays to thereby accommodate a special angle of view as needed in some situations.

Particularly the prism module 21 included in the light deflector 200, as illustrated in FIG. 1, typically includes at least one layer of prism sheet 211, where each layer of prism sheet 211 includes a plurality of strip-shaped convex prisms 2111 arranged in parallel on the surface of the side of each layer of prism sheet 211 away from the light guiding plate. If the prism module 21 includes more than two layers of prism sheets 211, then the extension directions of the strip-shaped convex prisms on the respective layers of prism sheets may vary from each other. Each strip-shaped convex prism 2111 functions as a prism capable of varying the propagation direction of light rays incident at an angle in accordance with the reflection and refraction laws of light to thereby concentrate the light rays exiting from the light guiding plate 100 so that they exit at some angle or less to thereby improve the brightness thereof in the range of angles.

Furthermore in the backlight module above according to the embodiment of the disclosure, as illustrated in FIG. 1, the light deflector 200 can further include: a light control film 221 located on the side of the prism module 21 away from the light guiding plate 100. Furthermore, as illustrated in FIG. 2 which is a schematic structural diagram of a light control film according to an embodiment of the disclosure, the light control film 221 includes a plurality of strip-shaped transmitting areas A and strip-shaped blocking areas B arranged in parallel and alternately, where there are micro blocking plates 2211 arranged in the strip-shaped blocking areas B. The light rays exiting from the light guiding plate 100 and passing the light control film 21 exit to the outside along the strip-shaped micro blocking plates 2211, so the exit direction of the light can typically be controlled by adjusting the inclination angle of the micro blocking plates 2211.

As can be apparent from the functions of the prism sheet 211 and the light control film 221, the propagation direction of the exiting light can be affected by varying the structure of the strip-shaped convex prisms 2111, or the inclination angle of the micro blocking plates 2211 in the light control film 221, to vary the angle of view covered by the exiting light. Accordingly, in the backlight module above according to an embodiment of the disclosure, the angle of view covered by the resulting exiting light rays can be varied by varying the structure of the prism sheet 211 and/or the light control film 221, particularly as described respectively in the following several implementations.

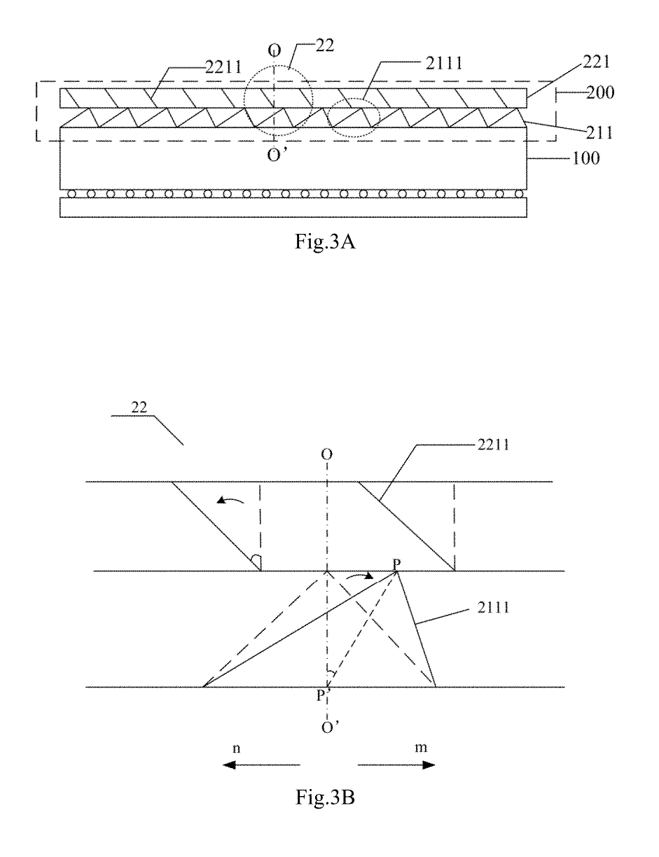

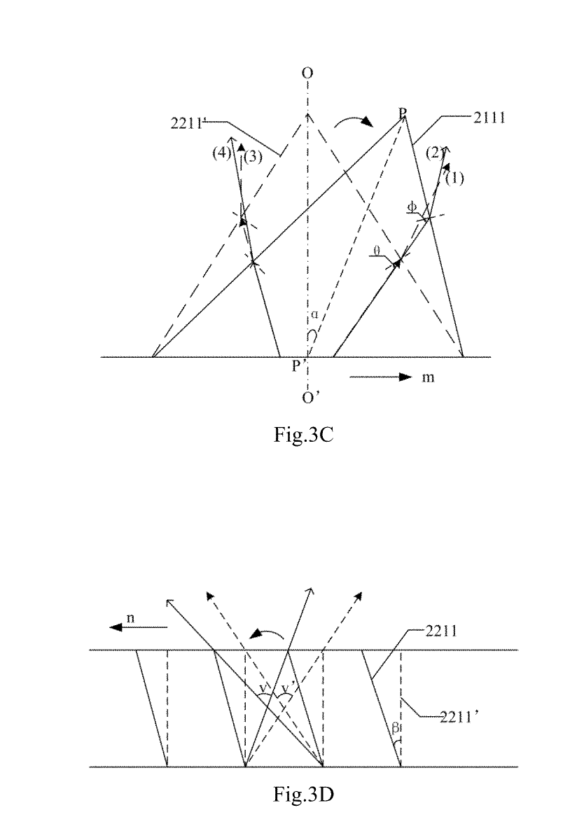

In an optional implementation, as illustrated in FIG. 3A which is a second schematic structural diagram of a backlight module according to an embodiment of the disclosure, the light deflector above includes both a prism module 21 located on the side of the light exit face of the light guiding plate 100, and a light control film 221 located on the side of the prism module 21 away from the light guiding plate 100. Moreover the prism module 21 includes at least one layer of prism sheet 211, where the extension direction of strip-shaped micro blocking plates 2211 in the light control film 221 is parallel to the extension direction of strip-shaped convex prisms 2111 in one of the at least one layer of prism sheet 211. FIG. 3A only illustrates one layer of prism sheet 211 parallel to the extension direction of the micro blocking plates 2211 while there are other possible layers of prism sheets which are not illustrated here.

Particularly in the light deflector above according to the embodiment of the disclosure, the light reflecting elements 22 configured to vary the light exit direction of the light rays to thereby make the angle of view of the light exiting from the backlight module asymmetric have the strip-shaped convex prisms 2111 and the micro blocking plates 2211 operate with each other. As illustrated in FIG. 3A, the surfaces of the respective micro blocking plates 2211 facing the strip-shaped transmitting areas are parallel to each other. The extension direction of the micro blocking plates 2211 is parallel to the extension direction of the respective strip-shaped convex prisms 2111 in the layer of prism sheet. In the backlight module above according to an embodiment of the disclosure, the light reflecting elements 22 configured to vary the angle of view each include at least one strip-shaped transmitting area, two adjacent micro blocking plates 2211, and at least one corresponding strip-shaped convex prism 2111. As illustrated in FIG. 3B which is a first schematic structural diagram of a light deflecting element according to an embodiment of the disclosure, the dotted lines represent the positions of the micro blocking plates 2211 and the strip-shaped convex prism 2111 before they are inclined, and the solid lines represent a structure in which the micro blocking plates 2211 and the strip-shaped convex prism 2111 are inclined in an embodiment of the disclosure, where the surfaces of the micro blocking plates 2211 are inclined in a first preset direction N from the normal OO′ (OO′ is a line connecting points of O and O, as illustrated in FIG. 3B), where the normal OO′ is perpendicular to the light exit face of the light guiding plate, and as illustrated in FIG. 3B, the angle between the inclined micro blocking plates 2211 and the normal OO′ is β; and the axis PP′ of the respective strip-shaped convex prism of the prism sheet is inclined in a second preset direction M from the normal OO′, and as illustrated in FIG. 3B, the angle between the axis PP′ of the inclined strip-shaped convex prism 2111 and the normal OO′ is α. The axis PP′ of the strip-shaped convex prism is a line connecting the tip of the strip-shaped convex prism with the middle point of the bottom side thereof, and the axis PP′ is perpendicular to the extension direction of the strip-shaped convex prism. In an embodiment of the disclosure, the first preset direction N and the second preset direction M are different directions pointing away from two respective sides of the normal OO′, and particularly as illustrated in FIG. 3B, the normal OO′ is perpendicular respectively to the first preset direction N and the second preset direction M. The micro blocking plates 2211 and the strip-shaped convex prism 2111 are arranged in the different directions away from the two sides of the normal so that the light rays exiting from the light guiding plate are inclined as a whole into the same side of the normal, and this is related to the structures of the micro blocking plates 2211 and the strip-shaped convex prism 2111. Principles of the micro blocking plates 2211 and the strip-shaped convex prism 2111 varying the propagation direction of light rays will be described below respectively.

Referring to FIG. 3C which is a light path comparison diagram on a strip-shaped convex prism according to an embodiment of the disclosure, 2111′ represents the strip-shaped convex prism which is not inclined, and 2111 represents the strip-shaped convex prism which is inclined. Light rays (1) and (3) in FIG. 3C represent light paths of light incident onto the strip-shaped convex prism which are not inclined, and light rays (2) and (4) represent light paths of light incident onto the strip-shaped convex prism which are inclined, where the light rays (1) and (2) are incident onto the strip-shaped convex prism in the same direction, i.e., to the right side in FIG. 3C, and the light rays (3) and (4) are incident onto the strip-shaped convex prism in the same direction, i.e., to the left side in FIG. 3C. In a real application, the material of the strip-shaped convex prism is typically a transparent material with a refractive index more than that of the air medium, so the light rays incident onto the respective strip-shaped convex prism and exiting to the outside may be refracted on the two sides of the strip-shaped convex prism at a refraction angle more than the incidence angle. If the strip-shaped convex prism is not inclined, and structured symmetric to the normal OO′, then the light rays may comply the refraction law of light, where the light paths of the light rays incident into the air through the sides of the strip-shaped convex prism are as illustrated by the light rays (1) and (3). In the backlight module above according to the embodiment of the disclosure, the strip-shaped convex prism 2111 is arranged inclined from the normal OO′, then as illustrated in FIG. 3C, the axis PP′ of the strip-shaped convex prism 2111 may be inclined at an angle of α in the second preset direction from the normal OO′ (inclined rightward in FIG. 3C), so that the light paths of the original incident light rays incident into the air through the sides of the inclined strip-shaped convex prism are as illustrated by the light rays (2) and (4). As illustrated in FIG. 3C, if the strip-shaped convex prism is inclined from the normal OO′ in an asymmetric structure, then the light rays incident onto the strip-shaped convex prism in the same original incidence direction may exit in a changed path, and in an exit direction deflected from the original exit direction to the opposite side to the inclination direction of the strip-shaped convex prism. Stated another way, if the strip-shaped convex prism 2111 is inclined rightward from the normal, then the light rays exiting from the strip-shaped convex prism may be deflected leftward from the original exiting light rays; and if the strip-shaped convex prism 2111 is inclined leftward from the normal, then the light rays exiting from the strip-shaped convex prism may be deflected rightward from the original exiting light rays. In a real application, with this characteristic, if the angle of view needs to be deflected, then the strip-shaped convex prism may be included to the opposite side to the deflection direction of the angle of view.

As illustrated in FIG. 3C, if the strip-shaped convex prism is not inclined, then the light rays may be incident onto the right side at an incidence angle of θ; and if the strip-shaped convex prism is inclined, then the light rays may be incident onto the right side at an incidence angle of φ. If the refractive index of the strip-shaped convex prism is N, and the refractive index of the air is 1; and θ′ represents a refraction angle of θ, and φ′ represents a refraction angle of φ, then the following two relationships will hold true in accordance with the refraction law of light:

n sin θ=sin θ′; and

n sin φ=sin φ′.

If the axis PP′ of the strip-shaped convex prism is inclined at an angle of α from the normal OO′, then φ=θ+α may be derived, and thereby the deflection angle of the exiting light rays after the strip-shaped convex prism is arranged may be calculated as:

Δ=φ′−θ′=arcsin(n sin θ)−arcsin [n sin(θ+α)].

FIG. 3D illustrates a comparison between angles of views before and after a micro blocking plate is inclined, where 2211′ represents the micro blocking plate which is not inclined, and 2211 represents the micro blocking plate which is inclined; and V′ represents the angle of view corresponding to the micro blocking plate which is not inclined, and V represents the angle of view corresponding to the micro blocking plate which is inclined. Since the strip-shaped micro blocking plate can make the light rays exit over the surface thereof, the inclination direction of the micro blocking plate may be arranged as needed for the angle of view to be deflected. In the embodiment of the disclosure, the micro blocking plate 2211 is inclined in the first preset direction N, that is, if the micro blocking plate is inclined leftward as illustrated in FIG. 3D, then the angle of view v covered by the exiting light rays may be deflected leftward. Thus in a real application, the micro blocking plate 2211 may be arranged inclined in the same direction as the deflection direction of the angle of view, for example, if the angle of view needs to be deflected leftward, then the micro blocking plate may be arranged inclined leftward; and if the angle of view needs to be deflected rightward, then the micro blocking plate may be arranged inclined rightward.

In the embodiment of the disclosure, the light deflecting element 22 includes at least one strip-shaped transmitting area and two adjacent micro blocking plates 2211, and at least one corresponding strip-shaped convex prism 2111. The extension direction of the micro blocking plates 2211 is parallel to the extension direction of the strip-shaped convex prism 2111, and if the micro blocking plates 2211 and the strip-shaped convex prism 2111 are arranged inclined from the normal OO′, then the angle of view corresponding to the light rays passing the light deflecting element 22 may also be deflected accordingly. It shall be noted that in an embodiment of the disclosure, the angle of view corresponding to the light rays passing the light deflecting element 22 may be deflected from two sides of an extending line through the micro blocking plates 2211 and the strip-shaped convex prism 2111. For example, if the micro blocking plates 2211 and the strip-shaped convex prism 2111 are arranged in parallel in the horizontal direction, then the angle of view may be arranged deflected upward or downward in the vertical direction. Likewise, if the micro blocking plates 2211 and the strip-shaped convex prism 2111 are arranged in parallel in the vertical direction, then the angle of view may be arranged deflected leftward or rightward in the horizontal direction. As can be apparent from the principle of deflecting the light rays by the micro blocking plates 2211 and the strip-shaped convex prism 2111, if the angle of view of the backlight module needs to be deflected in a preset direction, then the micro blocking plates may be arranged inclined in a proper direction, and also the strip-shaped convex prism may be arranged inclined in the opposite direction to the preset direction. For example, if the micro blocking plates 2211 and the strip-shaped convex prism 2111 are arranged in parallel in the vertical direction, and the angle of view corresponding to the exiting light needs to be deflected leftward in the horizontal direction, then the micro blocking plates 2211 may be arranged inclined leftward, and the strip-shaped convex prism 2111 may be arranged inclined rightward.

In the backlight module above according to an embodiment of the disclosure, the light deflecting elements 22 have the micro blocking plates 2211 and the strip-shaped convex prisms 2111 operate with each other, where the strip-shaped convex prism 2111 in the prism sheet has the sides thereof inclined to thereby vary the incident angle of the light rays incident onto the sides thereof, but the prism sheet can only be inclined at a limited angle; and the micro blocking plates 2211 deflect the light rays more directly in that typically the angle by which the angle of view needs to be deflected may be equal to the inclination angle of the micro blocking plates, but if the micro blocking plates are inclined at a too large angle, then they may degrade the efficiency of the light rays exiting, so in the embodiment of the disclosure, both the micro blocking plates 2211 and the strip-shaped convex prism 2111 can be arranged inclined from the normal line to thereby guarantee the efficiency of the light rays exiting, and flexibly set the deflection angle of the light rays.

As described above, in a preferred implementation, the micro blocking plates 2211 and the strip-shaped convex prism 2111 are inclined in opposite directions, and as illustrated in FIG. 3B, if the micro blocking plates 2211 are inclined in the first preset direction N from the normal OO′, and (the axis PP′ of) the strip-shaped convex prism 2111 is inclined in the second preset direction m from the normal OO′, then if they lie in a plane parallel to cross sections of the micro blocking plates 2211 and the strip-shaped convex prism 2111, and the normal OO′ runs in the vertical direction, as illustrated in FIG. 3B, then the first preset direction N and the second preset direction m may be two opposite directions on the two sides of the normal OO′. For example, they may be two opposite directions on the horizontal line as illustrated in FIG. 3B.

The disclosure has been made for an application scenario in which, e.g., an on-vehicle display, etc., needs to have its angle of view deflected at a preset angle, and selected inclination angles of the components in the light deflecting element at a specific deflected angle of view in the on-vehicle display by way of an example were experimented in the embodiments of the disclosures. If the angle of view on the on-vehicle display is deflected upward by 5 to 10 degrees, then a driver thereof may watch the display for the best effect, and under this precondition, the simulative experiment made on the structure of the light deflector as illustrated in FIG. 3A in an embodiment of the disclosure showed that if the axis PP′ of the strip-shaped convex prism 2111 is inclined downward by more than 0 and 15 degrees or less from the normal OO′, and the surfaces of the micro blocking plates 2211 facing the strip-shaped transmitting areas are inclined upward by more than 0 and 15 degrees or less from the normal OO′, then the angle of view corresponding to the resulting light exiting from the backlight module may be deflected by 5 to 10 degrees. It shall be noted that the endpoint value of 0 degrees may be precluded from the selected ranges of the inclination angles of the strip-shaped convex prism 2111 and the micro blocking plates 2211.

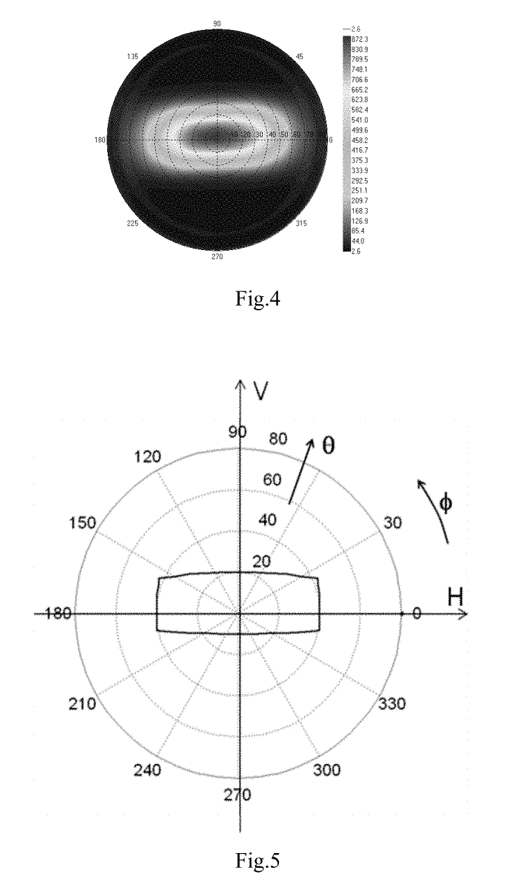

Furthermore as illustrated in FIG. 4 which is a distribution diagram of brightness according to an embodiment of the disclosure, in a scenario, the angle of view on the on-vehicle display needs to be deflected upward by 5 degrees so that the brightness in a core display area on the display after the angle of view is deflected falls into the brightness distribution as illustrated in FIG. 4. In an embodiment of the disclosure, firstly the strip-shaped convex prism in the prism sheet to deflect the angle of view is arranged in the horizontal direction, and the micro blocking plate in the light control film is arranged in the horizontal direction. The inclination angles of the micro blocking plates 2211 and the strip-shaped convex prism 2111 in the light deflecting element are such that the angle of view is deflected upward by 5 degrees. A simulative test was made showing that if the axis PP′ of the prism sheet 2111 is inclined by 4 to 6 degrees from the normal OO′, and the surfaces of the micro blocking plates 2211 facing the strip-shaped transmitting areas are inclined upward by 2 to 4 degrees from the normal OO′, then the brightness in the core watched area may be attained as indicated in FIG. 4.

Particularly as illustrated in FIG. 5 which is a first angle of view and detection area correspondence diagram according to an embodiment of the disclosure, the core display area on the display is the area in the box as illustrated in FIG. 5, and as illustrated in FIG. 5, H represents an angle of view in the horizontal direction, and V represents an angle of view in the vertical direction (θ and φ are spherical coordinates). In an embodiment of the disclosure, the angle of view needs to be deflected upward by 5 degrees, that is, the area in the box in FIG. 5 is an area translated upward by 5 degrees instead of being symmetric about the horizontal axis. Different grayscales in FIG. 4 represent different brightness, where the central area thereof corresponds to the core display area, so the brightness in the area in the box in FIG. 5 is detected and compared with preset brightness in FIG. 4 while the inclination angles of the strip-shaped convex prism 2111 and the micro blocking plates 2211 are being adjusted, and if the brightness reaches the preset brightness, then the corresponding inclination angles of the strip-shaped convex prism 2111 and the micro blocking plates 2211 may be preferred inclination angles. By way of an example, if the axis PP′ of the strip-shaped convex prism 2111 is inclined by 4 degrees from the normal OO′, and the surfaces of the micro blocking plates 2211 facing the strip-shaped transmitting areas are inclined by 4 degrees from the normal OO′. Alternatively, if the axis PP′ of the strip-shaped convex prism 2111 is inclined by 5 degrees from the normal OO′, and the surfaces of the micro blocking plates 2211 facing the strip-shaped transmitting areas are inclined by 3 degrees from the normal OO′. Alternatively, the axis PP′ of the strip-shaped convex prism 2111 is inclined by 6 degrees from the normal OO′, and the surfaces of the micro blocking plates 2211 facing the strip-shaped transmitting areas are inclined by 2 degrees from the normal OO′, then the brightness in the area in the box as illustrated in FIG. 5 may reach the preset brightness.

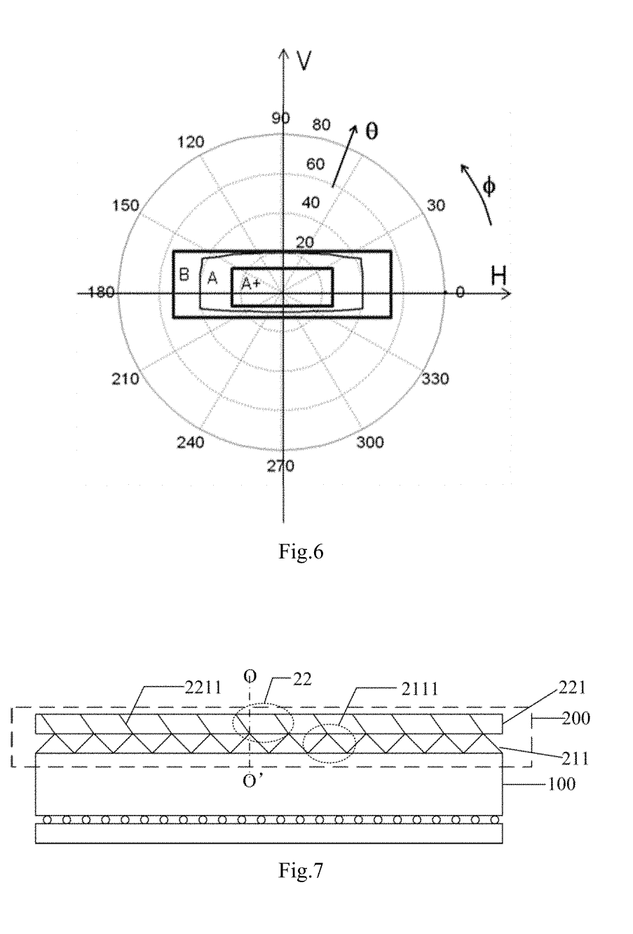

Furthermore, in order to enable the display brightness on the display after the angle of view is deflected to more approximate the brightness distribution as illustrated in FIG. 4, there may be a plurality of areas in which the brightness therein is detected and compared with the preset brightness concurrently so that the brightness distribution on the display after the inclination angles of the strip-shaped convex prism 2111 and the micro blocking plates 2211 are adjusted more approximates the brightness distribution as illustrated in FIG. 4. Further as illustrated in FIG. 6 which is a second angle of view and detection area correspondence diagram according to an embodiment of the disclosure, FIG. 6 illustrates a diagram of a corresponding detection area when the axis PP′ of the strip-shaped convex prism 2111 is inclined by 4 degrees from the normal OO′, and the surfaces of the micro blocking plates 2211 facing the strip-shaped transmitting areas is inclined by 4 degrees from the normal OO′, where the area A+ represents an area where a horizontal angle of view lies in the range of (−10°, 10°), and a vertical angle of view lies in the range of (−4°, 8°), the area A represents an area where a horizontal angle of view lies in the range of (−40°, 40°), and a vertical angle of view lies in the range of (−10°, 20°), and the area B represents an area where a horizontal angle of view lies in the range of (−50°, 50°), and a vertical angle of view lies in the range of (−10°, 20°). If all the lowest brightness in the three areas above can reach their corresponding preset brightness, then it may be determined that the adjusted angle of view on the display is satisfactory. For example, in the scenario above corresponding to the embodiment of the disclosure, if the lowest brightness in the area A+ can reach 600 cd/m², the lowest brightness in the area A can reach 320 cd/m², and the lowest brightness in the area B can reach 220 cd/m², then it may be determined that the adjusted angle of view is satisfactory.

The angle of view is deflected by 5 to 10 degrees only by way of an example in an embodiment of the disclosure, but there may be application scenarios in which the angle of view is deflected by other angles in a real application, so the inclination angles of the strip-shaped convex prism 2111 and the micro blocking plates 2211 need to be newly optimized for these application scenarios, where the inclination angles are still adjusted in accordance with the principle of deflecting the light rays as described above in the embodiments of the disclosure, so the strip-shaped convex prism 2111 and the micro blocking plates 2211 can be inclined at other inclination angles for the angle of view to be other deflected without departing from the spirit of the disclosure.

In another implementation, as illustrated in FIG. 7 which is a third schematic structural diagram of a backlight module according to an embodiment of the disclosure, the light deflector 200 includes a prism module 21 located on the side of the light exit face of the light guiding plate 100, and a light control film 221 located on the side of the prism module 21 away from the light guiding plate 100. The prism module 21 includes at least one layer of prism sheet 211, and each layer of prism sheet 211 includes a plurality of strip-shaped convex prisms 2111 arranged in parallel; and the light control film 221 includes strip-shaped transmitting areas and strip-shaped blocking areas arranged in parallel and alternately, and there are micro blocking plates 2211 arranged in the strip-shaped blocking areas. The light deflecting elements 22 are configured to vary the light exit direction of the light rays to thereby make the angle of view of the light exiting from the backlight module asymmetric only have the micro blocking plates 2211 operate alone. In an embodiment, the light deflecting elements 22 each include at least one strip-shaped transmitting area and two adjacent micro blocking plates 2211.

Particularly as illustrated in FIG. 7, the surface of the micro blocking plates 2211 facing the strip-shaped transmitting areas are inclined relative to the normal OO′, and the respective strip-shaped convex prisms 2111 in the prism sheet 211 are symmetric about the normal OO′. In an embodiment of the disclosure, since the respective strip-shaped convex prisms 2111 in the prism sheet are symmetric structured, the light rays passing the strip-shaped convex prisms 2111 are also distributed symmetrically, and the elements for deflecting the light rays as a whole are the micro blocking plates 2211 in the light control film. The inclination angle of the micro blocking plates can be varied so that the light rays exit to the outside in the inclination direction of the micro blocking plates. In a real application, the inclination angle of the micro blocking plates can be equal to the angle by which the angle of view is deflected as a whole. If the micro blocking plates operate as the light deflecting element to adjust the angle of view as described in this implementation, then it may be more straightforward than the implementation in which both the micro blocking plates and the strip-shaped convex prism are adjusted.

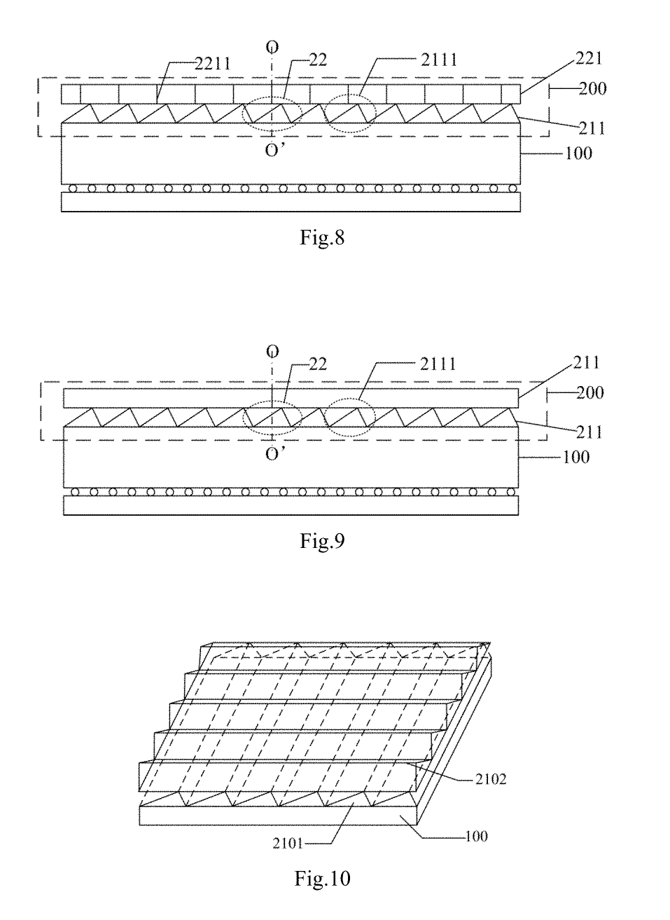

In another implementation, as illustrated in FIG. 8 which is a fourth schematic structural diagram of a backlight module according to an embodiment of the disclosure, the light deflector 200 includes a prism module 21 located on the side of the light exit face of the light guiding plate 100, and a light control film 221 located on the side of the prism module 21 away from the light guiding plate 100. The prism module 21 includes at least one layer of prism sheet 211, and each layer of prism sheet 211 includes a plurality of strip-shaped convex prisms 2111 that are arranged in parallel. The light control film 221 includes strip-shaped transmitting areas and strip-shaped blocking areas arranged in parallel and alternately, and there are micro blocking plates 2211 arranged in the strip-shaped blocking areas. The light deflecting elements 22 are configured to vary the light exit direction of the light rays to thereby make the angle of view of the light exiting from the backlight module asymmetric only have the strip-shaped convex prisms 2111 operate alone. In this embodiment, the light deflecting elements 22 each include at least one strip-shaped convex prism 2111.

Particularly as illustrated in FIG. 8, the axes of the respective strip-shaped convex prisms 2111 in the prism sheet 211 are inclined from the normal OO′; and the surfaces of the respective micro blocking plates 2211 facing the strip-shaped transmitting areas are parallel to each other, and all the surfaces of the micro blocking plates are parallel to the normal OO′. As can be apparent from the description above of deflecting light rays by the strip-shaped convex prism 2111, if the strip-shaped convex prism is adjusted to be inclined from the normal, then the angle of view of the exiting light may be deflected to two side directions perpendicular to the extension direction of the strip-shaped convex prism. For example, if the angle of view needs to be deflected upward by a preset angle in the vertical direction, then the extension direction of the strip-shaped convex prism will be adjusted to be the horizontal direction, and the strip-shaped convex prism will be arranged inclined downward.

As compared with the implementation in which the micro blocking plates 2211 operate as the light deflecting element, in this embodiment, the strip-shaped convex prisms 2111 operate as the light deflecting element without any blocking area, so the efficiency of the light rays exiting can be guaranteed. Particularly in an application scenario where the angle of view is deflected by a large angle, if the micro blocking plates operate alone as the light deflecting element, then the inclination angle of the micro blocking plates may be so large that significantly degrades the efficiency of the light rays exiting. Accordingly in such an application scenario, the implementation in which the strip-shaped convex prisms operate as the light deflecting element can be selected to thereby avoid the efficiency of the light rays exiting from being degraded.

In another implementation, as illustrated in FIG. 9 which is a fifth schematic structural diagram of a backlight module according to an embodiment of the disclosure, the light deflector 200 includes a prism module 21 located on the side of the light exit face of the light guiding plate 100. The prism module 21 includes at least one layer of prism sheet 211, and each layer of prism sheet 211 includes a plurality of strip-shaped convex prisms 2111 that are arranged in parallel. The light reflecting elements 22 configured to vary the light exit direction of the light rays to thereby make the angle of view of the light exiting from the backlight module asymmetric only have the strip-shaped convex prisms 2111. In this embodiment, the light reflecting elements 22 each include at least one strip-shaped convex prism 2111, and the axes of the respective strip-shaped convex prisms in the layer of prism sheet operating as the light reflecting elements are inclined from the normal OO′. The incline direction of the strip-shaped convex prisms 2111 in the prism sheet 211 is adjusted to thereby vary the angle of view corresponding to the resulting exiting light rays without any additional light control film, thus reducing the overall thickness of the backlight module, and thinning the display device.

Furthermore as illustrated in FIG. 10 which is a schematic structural diagram of a prism module according to an embodiment of the disclosure, the prism module 21 can include a first prism sheet 2101 and a second prism sheet 2102 stacked above each other. The first prism sheet 2101 is located between the light guiding plate 100 and the second prism sheet 2102. In a real application, in order to adjust the angle of view in a plurality of directions, the extension direction of the strip-shaped convex prisms of the first prism sheet 2101 can be set different from the extension direction of the strip-shaped convex prisms of the second prism sheet 2102, and all the axes of the respective strip-shaped convex prisms of the first prism sheet 2101 and the second prism sheet 2102 can be set to be inclined from the normal, to thereby adjust the view of angle to be deflected perpendicular to the extension directions of the strip-shaped convex prisms. In a general implementation, as illustrated in FIG. 10, the extension direction of the strip-shaped convex prisms of the first prism sheet 2101 can be perpendicular to the extension direction of the strip-shaped convex prisms of the second prism sheet 2102.

In a real application, the material of the prism module 21 may be selected from material such as transparent resin or transparent glass, and generally the refractive index of the material of which the prism module 21 is made is more than that of the air. If the prism module is made of a different material, then the inclination angle of the strip-shaped convex prisms need to be optimized dependent on the angle by which the angle of view needs to be deflected in practice, and the refractive index of the material, although the value of the inclination angle of the strip-shaped convex prism will not be limited to any particular value in the embodiment of the disclosure.

In a particular implementation, in the backlight module above according to the embodiments of the disclosure, as illustrated in FIG. 1, FIG. 3A to FIG. 3C, and FIG. 7 to FIG. 10, all the cross sections of the strip-shaped convex prisms 2111 can be triangular in shape. If the strip-shaped convex prisms are arranged inclined from the normal, then the angles between the two respective sides of the triangle of each strip-shaped convex prism 2111 with the bottom side thereof are unequal, and the bottom side thereof is parallel to the light exit face of the light guiding plate.

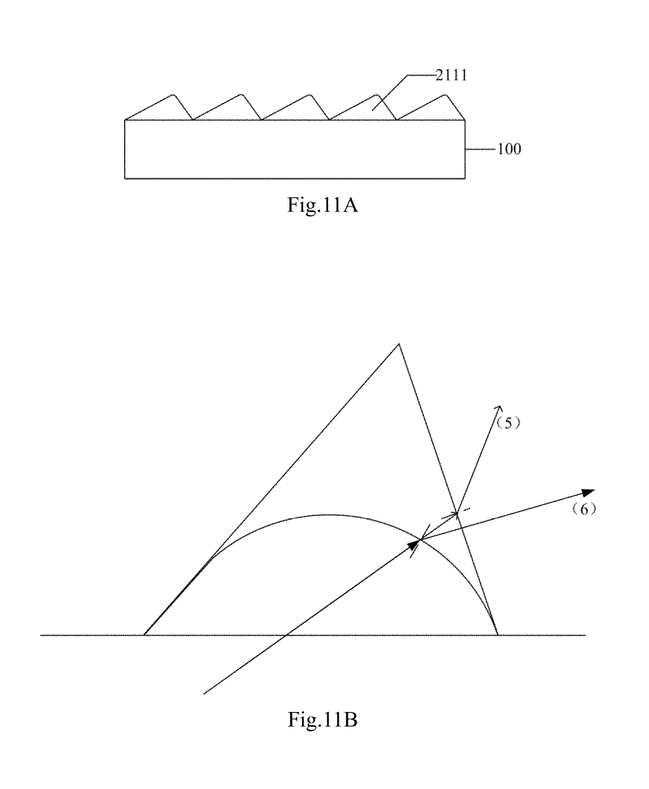

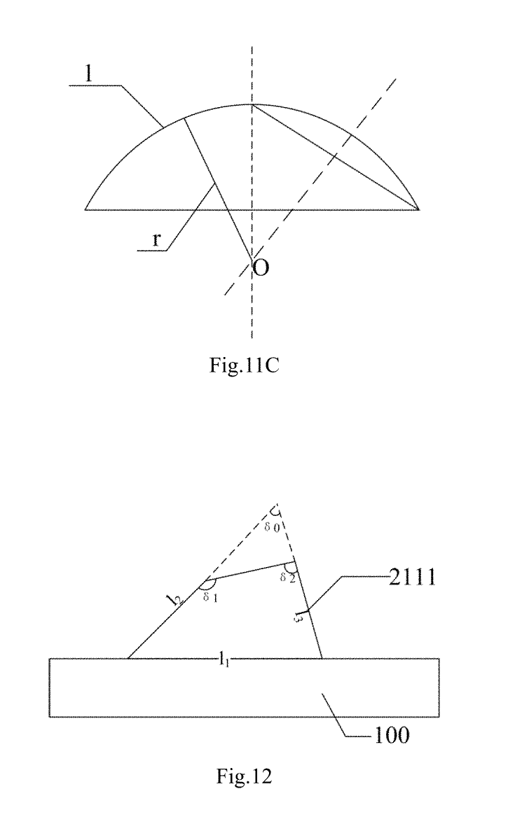

In a particular implementation, as illustrated in FIG. 11A which is a first schematic sectional view of a strip-shaped convex prism according to an embodiment of the disclosure, the cross section of the strip-shaped convex prism can be a rounded-corner triangle with a rounded top corner, where the top corner of the cross section can be rounded to thereby facilitate an improvement in brightness of exiting light at a large angle of view over a sharp-angled corner thereof. A principle thereof is as illustrated in FIG. 11B which is a light path comparison diagram at the top corner of the strip-shaped convex prism according to an embodiment of the disclosure. If the top corner is a rounded corner, then if the light rays exiting from the light guiding plate are incident into the rounded-corner area, then as compared with the light rays incident into the sharp-angled corner, given the light rays incident in the same direction, and refracted respectively at the rounded corner and the sharp-angled corner. The light rays (6) refracted at the rounded corner may exit at a larger angle of view than that of the light rays (5) refracted at the sharp-angled corner as illustrated in FIG. 11B, so an improvement in display brightness at a large angle can be further facilitated using the strip-shaped convex prism with the cross section which is the rounded-corner triangle.

Furthermore the rounded corner of the rounded-corner triangle is a segment of arc with a corresponding radius which can be set more than or equal to 0.003 mm, and less than or equal to 0.2 mm. As illustrated in FIG. 11C which is a schematic diagram of an arc at the top corner of the strip-shaped convex prism according to an embodiment of the disclosure, the radius of the arc 1 is R as illustrated, and the center of the arc 1 is the intersection of middle perpendicular lines to two solid segments of lines in FIG. 11C (see the two dotted segments of lines in FIG. 11C).

In another implementation, as illustrated in FIG. 12 which is a second schematic sectional view of a strip-shaped convex prism according to an embodiment of the disclosure, the cross section of the strip-shaped convex prism, the cross section of the strip-shaped convex prism is a polygon including at least four sides. The bottom side of the polygon is parallel to the light exit face of the light guiding plate, and respective angles of top corners of the polygon away from the light guiding plate are greater than the angle between the two sides connected with the bottom side. Taking the polygon as illustrated in FIG. 12 as an example, typically the cross section of the strip-shaped convex prism is a triangle with a top corner being the sharp-angled corner as represented by the dotted lines in FIG. 12; and in an embodiment of the disclosure, the cross section of the strip-shaped convex prism is a quadrangle, where the bottom side l₁ of the quadrangle is parallel to the light exit face of the light guiding plate 100, respective angles of top corners thereof away from the light guiding plate 100 (δ1 and δ2) are greater than the angle δ0 between the two sides l₂ and l₃ connected with the bottom side l₁, and the angle δ0 is also the angle of the top corner of the cross section which is a triangle. Like the rounded-corner triangle above, the pattern of the cross section of the polygon according to the embodiment of the disclosure also can improve the brightness at a large angle of view.

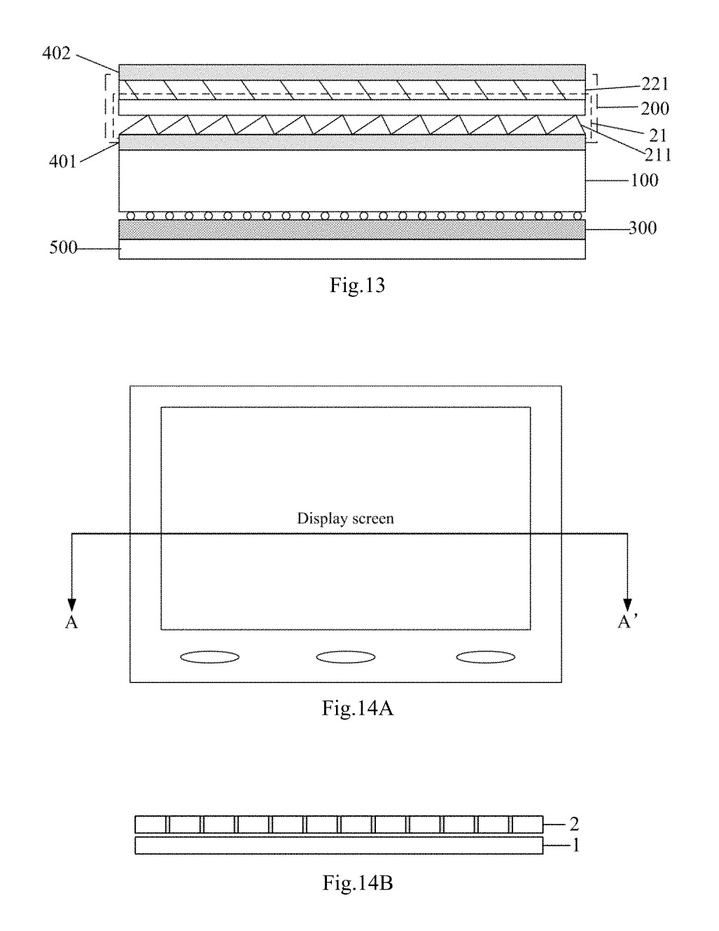

In a real application, reference can be made to FIG. 13 for the structure of the backlight module according to the embodiment of the disclosure, and FIG. 13 illustrates a sixth schematic structural diagram of a backlight module according to an embodiment of the disclosure. As illustrated in FIG. 13, the backlight module further includes a reflecting sheet 300 located on the side of the light guiding plate 100 away from the light deflector 200. Furthermore the backlight module further includes a first diffusing sheet 401 located between the light guiding plate 100 and the light deflector 200, and/or a second diffusing sheet 402 located on the side of the light deflector 200 away from the light guiding plate 100, and a back frame 500 located on the side of the reflecting sheet 300 away from the light guiding plate 100. The reflecting sheet 300 can reflect the light rays, exiting from the light guiding plate 100 toward the side of the back frame 500, back into the light guiding plate 100 to thereby improve the utilization ratio of the light. The first diffusing sheet 401 and the second diffusing sheet 402 can make the light uniform, widen the angle of view, blur the defects of light spots, and improve the luminance. In a real application, the back frame can be embodied as a metal iron frame, etc., although the embodiment of the disclosure will not be limited thereto.

Based upon the same novel inventive concept, an embodiment of the disclosure further provides a display device including the backlight module according to any one of the embodiments above, and a display panel located on the light exit side of the backlight module. The display device can be a display device such as a liquid crystal panel, a liquid crystal display, or an electronic paper, or may be a mobile device such as a mobile phone, or a smart phone. If the display panel is a liquid crystal display panel, then it may include a liquid crystal layer.

If the display device above is an on-vehicle display, for example, then as illustrated in FIG. 14A which is a schematic plan view of an on-vehicle display according to an embodiment of the disclosure, the on-vehicle display may include a display screen, and as illustrated in FIG. 14B which is a cross sectional view of the display screen along AA′, the display screen may include the backlight module 1 according to any one of the embodiments above, and a liquid crystal display panel 2 located on the light exit side of the backlight module. If the light deflecting elements in the backlight module 1 are arranged in an asymmetric structure inclined from the normal, then the overall exit direction of the light rays exiting from the backlight module may be deflected in a preset direction, so that the angle of view on the display panel can be deflected in the preset direction above after the light rays pass the liquid crystal display panel, to thereby accommodate a special asymmetric angle of view as required.

In the backlight module and the display device according to an embodiment of the disclosure, the backlight module includes the light guiding plate, and the light deflector arranged on the side of the light exit face of the light guiding plate. The light deflector includes the prism module and the light deflector includes a plurality of light deflecting elements having a same structure, where the respective light deflecting elements are asymmetrically structured inclined from the normal perpendicular to the light exit face of the light guiding plate so that an angle of view of light exiting from the backlight module is deflected from the normal. The prism module includes at least one layer of prism sheet, and there are a plurality of strip-shaped convex prisms arranged in parallel on the surfaces of the prism sheet away from the light guiding plate. The light deflecting elements in the asymmetrical structure are arranged so that the light exiting from the backlight module is deflected from the original direction to the normal to thereby make the exiting light also deflected, thus creating the special asymmetrical angle of view as required on the display screen.

Although the preferred embodiments of the disclosure have been described, those skilled in the art benefiting from the underlying inventive concept can make additional modifications and variations to these embodiments. Therefore the appended claims are intended to be construed as encompassing the preferred embodiments and all the modifications and variations coming into the scope of the disclosure.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A backlight module, comprising: a light guiding plate, and a light deflector arranged on the side of a light exit face of the light guiding plate, wherein:
the light deflector comprises:
a prism module;
a plurality of light deflecting elements having a same structure, wherein respective light deflecting elements are asymmetrically structured to be inclined from a normal, wherein the normal is perpendicular to the light exit face of the light guiding plate, so that an angle of view of light exiting from the backlight module is deflected from the normal; and
the prism module further comprises at least one layer of prism sheet comprising of a plurality of strip-shaped convex prisms arranged in parallel on the surface of the prism sheet away from the light guiding plate.

2. The backlight module according to claim 1, wherein the light deflector further comprises a light control film located on the side of the prism module away from the light guiding plate; and
the light control film comprises a plurality of strip-shaped transmitting areas and strip-shaped blocking areas arranged in parallel and alternately, and there are micro blocking plates arranged in the strip-shaped blocking areas.

3. The backlight module according to claim 2, wherein the surfaces of the micro blocking plates facing the strip-shaped transmitting areas are parallel to each other, and inclined in a first preset direction from the normal;
the extension direction of the micro blocking plates is parallel to the extension direction of respective strip-shaped convex prisms in the layer of prism sheet, and axes of the respective strip-shaped convex prisms in the layer of prism sheet are inclined in a second preset direction from the normal, wherein an axis of a strip-shaped convex prism is a line connecting a tip of the strip-shaped convex prism with a middle point of a bottom side of the strip-shaped convex prism, and the connecting line is perpendicular to the extension direction of the strip-shaped convex prism;
the first preset direction is different from the second preset direction; and
each of the light deflecting elements comprises at least one of the strip-shaped transmitting areas, and two adjacent ones of the micro blocking plates, and at least corresponding one of the strip-shaped convex prisms.

4. The backlight module according to claim 3, wherein the first preset direction and the second preset direction are two opposite directions, wherein the two opposite directions are in a plane parallel to the cross sections of the strip-shaped convex prisms and are on two sides of the normal.

5. The backlight module according to claim 4, wherein the axes of the strip-shaped convex prisms are inclined from the normal at an angle of 0 to 15 degrees, and the surfaces of the micro blocking plates facing the strip-shaped transmitting areas are inclined from the normal at an angle of 0 to 15 degrees.

6. The backlight module according to claim 5, wherein the axes of the strip-shaped convex prisms are inclined from the normal at an angle of 4 to 6 degrees, and the surfaces of the micro blocking plates facing the strip-shaped transmitting areas are inclined from the normal at an angle of 2 to 4 degrees.

7. The backlight module according to claim 6, wherein the axes of the strip-shaped convex prisms are inclined from the normal at an angle of 6 degrees, and the surfaces of the micro blocking plates facing the strip-shaped transmitting areas are inclined from the normal at an angle of 4 degrees.

8. The backlight module according to claim 2, wherein the surfaces of the micro blocking plates facing the strip-shaped transmitting areas are inclined from the normal;
each of the light deflecting elements comprises at least one of the strip-shaped transmitting areas, and two adjacent ones of the micro blocking plates; and
respective strip-shaped convex prisms in the prism sheet are symmetric about the normal.

9. The backlight module according to claim 2, wherein axes of respective strip-shaped convex prisms in the at least one layer of prism sheet are inclined from the normal, wherein an axis of a strip-shaped convex prism is a line connecting a tip of the strip-shaped convex prism with a middle point of a bottom side of the strip-shaped convex prism, and the connecting line is perpendicular to the extension direction of the strip-shaped convex prism;
each of the light deflecting elements comprises at least one of the strip-shaped convex prisms, the axis of the at least one of the strip-shaped convex prisms is inclined from the normal; and
the surfaces of respective micro blocking plates facing the strip-shaped transmitting areas are parallel to each other, and parallel to the normal.

10. The backlight module according to claim 1, wherein axes of respective strip-shaped convex prisms in the at least one layer of prism sheet are inclined from the normal, wherein an axis of a strip-shaped convex prism is a line connecting a tip of the strip-shaped convex prism with a middle point of a bottom side of the strip-shaped convex prism, and the connecting line is perpendicular to the extension direction of the strip-shaped convex prism; and
each of the light deflecting elements comprises at least one of the strip-shaped convex prisms, and the axis of the at least one of the strip-shaped convex prisms is inclined from the normal.

11. The backlight module according to claim 10, wherein the prism module comprises a first prism sheet and a second prism sheet stacked above each other, and the first prism sheet is located between the light guiding plate and the second prism sheet; and
axes of respective strip-shaped convex prisms in the first prism sheet and the second prism sheet are inclined from the normal, and the extension direction of the strip-shaped convex prisms of the first prism sheet is different from the extension direction of the strip-shaped convex prisms of the second prism sheet.

12. The backlight module according to claim 10, wherein the extension direction of the strip-shaped convex prisms of the first prism sheet is perpendicular to the extension direction of the strip-shaped convex prisms of the second prism sheet.

13. The backlight module according to claim 1, wherein the material of the prism module is transparent resin.

14. The backlight module according to claim 1, wherein the cross section of each of the strip-shaped convex prisms is a triangle; and
angles between two respective sides of the triangle with the bottom side of the triangle are unequal, and the bottom side of the triangle is parallel to the light exit face of the light guiding plate.

15. The backlight module according to claim 1, wherein the cross section of each of the strip-shaped convex prisms is a rounded-corner triangle with a top corner which is a rounded corner.

16. The backlight module according to claim 15, wherein the radius corresponding to the rounded corner is more than or equal to 0.003 mm, and less than or equal to 0.2 mm.

17. The backlight module according to claim 1, wherein the cross section of each of the strip-shaped convex prisms is a polygon comprising at least four sides;
respective angles of top corners of the polygon away from the light guiding plate are greater than the angle between the two sides connected with the bottom side, and the bottom side of the polygon is parallel to the light exit face of the light guiding plate.

18. The backlight module according to claim 1, wherein the backlight module further comprises a reflecting sheet located on the side of the light guiding plate away from the light deflector; wherein the backlight module further comprises a back frame located on the side of the reflecting sheet away from the light guiding plate.

19. The backlight module according to claim 1, wherein the backlight module further comprises a first diffusing sheet located between the light guiding plate and the light deflector, and/or a second diffusing sheet located on the side of the light deflector away from the light guiding plate.

20. A display device, comprising a backlight module, and a display panel located on the light exit side of the backlight module, wherein the backlight module comprises: a light guiding plate, and a light deflector arranged on the side of a light exit face of the light guiding plate, wherein:
the light deflector comprises:
a prism module;
a plurality of light deflecting elements having a same structure, wherein respective light deflecting elements are asymmetrically structured to be inclined from a normal, wherein the normal is perpendicular to the light exit face of the light guiding plate, so that an angle of view of light exiting from the backlight module is deflected from the normal; and
the prism module further comprises at least one layer of prism sheet comprising of a plurality of strip-shaped convex prisms arranged in parallel on the surface of the prism sheet away from the light guiding plate.
